(19) United States
(12) Patent Application Publication
(10) Pub. No.: US 2024/0037749 A1
(43) Pub. Date: Feb. 1, 2024

(54) SYSTEMS AND METHODS FOR THE IMPROVED DETECTION OF PLANTS

(71) Applicant: Terramera, Inc., Vancouver (CA)

(72) Inventors: Maryamsadat RASOULIDANESH, Vancouver (CA); Hoda AGHAEI, Vancouver (CA); Travis Godwin GOOD, Vancouver (CA)

(21) Appl. No.: 18/265,350

(22) PCT Filed: Dec. 7, 2021
(86) PCT No.: PCT/CA2021/051749

§ 371 Date: Jun. 5, 2023

Related U.S. Application Data
(60) Provisional application No. 63/147,084, filed on Feb. 8, 2021.
(60) Provisional application No. 63/122,821, filed on Dec. 8, 2020.

(51) Int. Cl. G06T 7/11

(52) U.S. Cl. CPC G06T 7/11; G06T 2207/30188; G06T 2207/20084; G06T 2207/10024

(57) ABSTRACT

Systems and methods for detecting plants in a sequence of images are provided. A plant is predicted to be in a detection region in an image and the plant is tracked across multiple images. A tracker retains a memory of the plants past position and updates a tracking region for each subsequent image based on the memory and the new images, thus using temporal information to augment detection performance. The plant can be substantially stationary and exhibit growth between images. Tracking substantially stationary plants can improve detection of the plant between images relative to detection alone. The tracking region can be updated based on the substantially stationary position of the plant, for instance by combining the tracking region with further predictions of plant position in subsequent images. Combining can involve determining a union.

### CROSS-REFERENCE TO RELATED APPLICATIONS

This application claims priority to, and the benefit of, U.S. provisional patent application Nos. 63/122,821 and 63/147,084, both entitled Systems and Methods for the Improved Detection of Plants, the entireties of which are incorporated by reference herein for all purposes.

### TECHNICAL FIELD

The present disclosure relates generally to machine vision, and in particular to systems and methods for detecting plants in images.

### BACKGROUND

Plants are grown for a variety of purposes, including as crops, ornamentation, as experiments, and for other purposes. It is sometimes desirable to monitor plants as they grow, for example to assess the productivity of a field, to assess the effect of plant health and/or pesticidal compositions applied to plants (e.g. grown experimentally to test such compositions), and/or for interest (e.g. in the case of ornamental plants).

Monitoring plants can present logistical and/or practical challenges. Plants grown in large quantities (such as in a field and/or experimental trial), in a controlled environment (such as in a growth chamber), and/or in a remote setting (such as in a home while the residents are absent) may be difficult or impossible to monitor by some techniques, such as manual inspection.

Machine vision techniques have been applied to detect plants in certain applications. For example, leaves have been detected via labelling, segmentation, and extraction for the purpose of species identification by Kumar N. et al. (2012), “Leafsnap: A Computer Vision System for Automatic Plant Species Identification”. In: Fitzgibbon A., Lazebnik S., Perona P., Sato Y., Schmid C. (eds) Computer Vision—ECCV 2012. ECCV 2012. Lecture Notes in Computer Science, vol 7573. Springer, Berlin, Heidelberg. doi: 10.1007/978-3-642-33709-3_36. As another example, plant leaves have been segmented in fluorescence plant videos via template matching techniques to assist in plant-phenotyping applications, e.g. by X. Yin, X. Liu, J. Chen and D. M. Kramer, “Multi-leaf tracking from fluorescence plant videos,” 2014 IEEE International Conference on Image Processing (ICIP), Paris, 2014, pp. 408-412, doi: 10.1109/ICIP.2014.7025081.

Performance of such machine-vision techniques can vary. For instance, machine vision techniques sometimes have reduced accuracy when the leaves of different plants overlap in an image and/or are occluded by other objects, when plants undergo changes in colouration (e.g. due to nutrition, treatments, or the like), and/or when plants are small and correspondingly harder to distinguish in an image. Challenges such as these and others can lead to plants sometimes not being detected, and/or non-plant objects being mis-labelled as plants. Depending on the application, such defects in accuracy, especially if at unacceptably high rates, may degrade overall performance in the context of the application and/or may make such machine-vision approaches unsuitable for adoption. Other challenges may arise additionally or alternatively, e.g. arising from a quantity of data required for adequate training, a quantity of memory or other storage for training or inference, and/or time efficiency in training or inference.

There is thus a general desire for improved systems and methods for detecting plants.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

Aspects of the present disclosure provide systems and methods for detecting plants in a sequence of images. In some embodiments, a machine learning model (the detector) detects a region of an image in which a plant is predicted to be and a second machine learning model (the tracker) tracks a region across multiple images in which the plant is predicted to be. The tracker retains a memory of the plant's (predicted) past position and updates the tracking region for each subsequent image based on that memory and the new information provided by the image. In some implementations, the plant is substantially stationary, and exhibits growth between images. Although it is counter-intuitive to use a technique more commonly seen for tracking motion across an image, tracking the plant via the tracker can improve detection of the plant between images relative to the detector alone. In some embodiments, the tracking region is updated based on the substantially stationary position of the plant, e.g. by combining the tracking region with further predictions of plant position in subsequent images by the detector.

One aspect of the invention provides systems and methods for detecting one or more plants in a sequence of images. The system comprises one or more processors and a memory storing instructions which cause the one or more processors to perform the operations of the method. The method comprises detecting one or more plants in a first image of the sequence of images by, for at least a first plant of the one or more plants: generating a first detection region for the first plant based on the first image; initializing a first tracker for the first plant based on the first detection region, the first tracker having a first state; and generating a first tracking region by the first tracker for the first plant based on the first state. The method further comprises detecting at least the first plant in a second image of the sequence of images by, for at least the first plant: updating the first tracker to have a second state based on the second image and the first state; and generating a second tracking region based on the second state.

In some embodiments, a center of mass of the plant is substantially stationary between the first and second images. In some embodiments, the first plant exhibits growth between the first and second images

In some embodiments, detecting at least the first plant in the second image further comprises: generating a second detection region for the first plant based on the second image; updating the first tracker to have an updated second state based on the second detection region and the second state; and generating an updated second tracking region based on the second state. In some embodiments updating the first tracker to have the updated second state comprises determining a union of the second detection region and the second tracking region to generate an updated second detection region and updating the first tracker based on the updated second detection region.

In some embodiments updating the first tracker to have the updated second state comprises matching the second tracking region to the second detection region based on a position of the second detection region relative to a position of at least one of: the second tracking region and another tracking region generated by the first tracker for another image of the sequence of images. In some embodiments matching the second tracking region to the second detection region based on the first and second positions comprises matching the second tracking region to the second detection region based on a distance between a center of the second detection region and a center of the at least one of: the second tracking region and the another tracking region. In some embodiments the center of the second detection region comprises a prediction of the first plant's center of mass. In some embodiments matching the second tracking region to the second detection region comprises generating a determination that the distance is less than at least a matching threshold distance and selecting the second detection region from a plurality of detection regions based on the determination.

In some embodiments the method further comprises: detecting a second plant in a first second-plant (2P) image of the sequence of images by initializing a second tracker for the second plant based on the first 2P image, the second tracker having a first 2P state; detecting the second plant in a second 2P image of the sequence of images by: updating the second tracker to have a second 2P state based on the first 2P state and the second 2P image; wherein the first 2P image comprises at least one of the first image, the second image, and a third image of the sequence of images, and the second 2P image comprises at least one of the second image, the third image, and a fourth image of the sequence of images, the second 2P image subsequent to the first 2P image in the sequence of images.

In some embodiments detecting the second plant in the second 2P image comprises: generating a 2P determination that less than a matching threshold area of at least one of: the first 2P tracking region and a first 2P detection region generated for the second plant overlaps with each of at least one of: one or more detection regions and one or more tracking regions for one or more other plants, the one or more other plants comprising at least the first plant; and validating the at least one of: the first 2P tracking region and a first 2P detection region based on the 2P determination.

In some embodiments, the method comprises generating a third detection region; generating a 3P determination that more than the matching threshold area of the third detection region overlaps with at least one of: the first detection region, the second detection region, the first 2P detection region, and the second 2P detection region; and invalidating the third detection region based on the 3P determination. In some embodiments, the matching threshold area comprises 50% of an area of at least one of: the first 2P tracking region, the first 2P detection region, any of the one or more detection regions for the one or more other plants, and any of the one or more tracking regions for one or more other plants.

In some embodiments detecting one or more plants in a first image comprises detecting up to n plants in the sequences of images, the up to n plants comprising the first plant, for a predetermined n; generating the first detection region comprises: generating at least n+1 detection regions based on the sequence of images; and selecting up to n detection regions of the at least n+1 detection regions; initializing the first tracker comprises initializing up to n trackers, each of the up to n trackers comprising a corresponding tracking region based on a corresponding one of the up to n detection regions; and the up to n plants comprise the first plant, the up to n detection regions comprise the first detection region, and the up to n trackers comprise the first tracker.

In some embodiments selecting up to n selected detection regions comprises: determining, for each of the n+1 detection regions, an associated probability that the detection region contains a plant based on trained parameters of a machine learning model; determining, for each of the n selected detection regions, that the associated probability for the selected detection region is at least as great as the associated probability for each of the n+1 detection regions not in the up to n selected detection regions; and selecting up to n of the n+1 detection regions based on the determining, for each of the n selected detection regions, that the associated probability for the selected detection region is at least as great as the associated probability for each of the n+1 detection regions not in the up to n selected detection regions.

In some embodiments, selecting up to n selected detection regions comprises: for each of a first and second candidate detection region, determining a spectral characteristic value based on a corresponding portion of the first image; and selecting the first candidate detection region and rejecting the second candidate detection region based on a comparison of the spectral characteristic value for the first candidate detection region and the spectral characteristic value for the second candidate detection region.

In some embodiments, the spectral characteristic value for at least the first candidate detection region is based on a histogram distance between the corresponding portion of the first image for the first candidate detection region and one or more corresponding portions of the first image for one or more other ones of the n+1 detection regions; and selecting the first candidate detection region comprises determining that the spectral characteristic value for the first candidate detection region is less than the spectral characteristic value for the second candidate detection region.

In some embodiments generating a first detection region comprises: extracting a plant mask based on trained parameters of a machine learning model, the plant mask mapping regions of the first image to probabilities that the regions include a plant; identifying one or more objects in the first image based on the plant mask; generating the first detection region for the first plant based on at least one of the one or more objects in the plant mask. In some embodiments the first detection region comprises a bounding box.

In some embodiments extracting the plant mask comprises extracting a background mask based on the trained parameters of the machine learning model, the background mask mapping regions of the first image to probabilities that the regions include non-plant background; and generating the plant mask based on an inversion of the background mask.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A shows schematically an exemplary system for detection of plants in a first mode of operation where the system initializes a tracker.

FIG. 1B shows schematically the exemplary system of FIG. 1A in a second mode of operation where the system updates the tracker.

FIG. 2 shows a flowchart for an exemplary method for detection of plants, such as may be performed by the system of FIGS. 1A and 1B.

FIG. 3 shows a flowchart for an exemplary method for detection of plants, which is an exemplary implementation of the method of FIG. 2.

FIG. 4A shows a 1^{st} image of an example sequence of images processed by an exemplary implementation of the system of FIGS. 1A and 1B according to an example implementation of the methods of FIGS. 2 and 3.

FIG. 4B shows an example plant mask generated for the image of FIG. 4A according to the example implementations of systems and methods mentioned with respect to FIG. 4A.

FIG. 4C shows the image of FIG. 4A overlaid with detection regions generated according to the example implementations of systems and method mentioned with respect to FIG. 4A based on the plant masks of FIG. 4B.

FIG. 4D shows the image of FIG. 4A overlaid with improved detection regions generated according to the example implementations of systems and method mentioned with respect to FIG. 4A. (FIGS. 4A, 4B, 4C, and 4D are referred to collectively and individually herein as “FIG. 4”.)

FIG. 5A shows a 14^{th} image of the sequence of images of FIG. 4A, captured roughly 6 days after the image of FIG. 4A, processed according to the example implementations of systems and methods mentioned with respect to FIG. 4A.

FIG. 5B shows an example plant mask generated for the image of FIG. 5A according to the example implementations of systems and methods mentioned with respect to FIG. 4A.

FIG. 5C shows the image of FIG. 5A overlaid with detection regions generated according to the example implementations of systems and method mentioned with respect to FIG. 4A based on the plant masks of FIG. 5B.

FIG. 5D shows the image of FIG. 5A overlaid with improved detection regions generated according to the example implementations of systems and method mentioned with respect to FIG. 4A. (FIGS. 5A, 5B, 5C, and 5D are referred to collectively and individually herein as “FIG. 5”.)

FIG. 6 shows a first exemplary operating environment that includes at least one computing system for performing methods described herein, such as the methods of FIGS. 2 and 3.

FIG. 7A shows an example image of plants overlaid with fitted circles according to an exemplary embodiment of a plant diameter-estimating application of this disclosure.

FIG. 7B shows the example image of FIG. 7A overlaid with a segmentation mask according to an exemplary embodiment of a plant biomass-estimating application of this disclosure.

FIG. 8 is a flowchart of an example method 800 for monitoring plant health.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

As noted above, aspects of the present disclosure provide systems and methods for detecting plants in a sequence of images. The system performs a method which involves detecting a region of an image in which a plant is predicted to be (e.g. via a first machine learning model, the detector) and tracking a region across multiple images in which the plant is predicted to be (e.g. via a second machine learning model, the tracker). The tracker retains a memory of the plant's (predicted) past position and updates the tracking region for each subsequent image based on that memory and the new information provided by the image. This can be characterized as using temporal information to augment detection performance.

In some implementations, the plant is substantially stationary and exhibits growth between images. Although it is counter-intuitive to use a technique more commonly seen for tracking motion across an image, tracking substantially stationary plants via the tracker can improve detection of the plant between images relative to the detector alone. In some embodiments, the tracking region is updated based on the substantially stationary position of the plant, e.g. by combining the tracking region with further predictions of plant position in subsequent images by the detector.

“Substantially stationary”, as used herein and in the appended claims, allows for plants' growth and nastic and tropic movement, as well as incidental environmentally-related movement (e.g. due to movement of surrounding air) and/or potential incidental movement of the imaging apparatus relative to the plant (e.g. jostling or realignment of the relative positions of the plant and imaging apparatus) creating apparent movement of the plant within the field of view. For example, a plant growing in a planter which remains in place relative to the imaging apparatus from one image to the next is substantially stationary, whereas (for example) if the planter were moved by several plant diameters across the field of view between images then it is not substantially stationary between those images. In some embodiments, plants may be in motion relative to an imaging apparatus after a first image is taken and before the next image is taken (e.g. because the imaging apparatus is being moved between plants, and/or the plants are being moved out of and back into frame between images, e.g. via circulation on a conveyor belt), but so long as the position of the plant in each image substantially corresponds the plant is still “substantially stationary” between those images.

For example, in at least one exemplary embodiment images were captured by a camera semi-daily over the course of several weeks, starting shortly after germination. The plants and camera have relatively fixed relative positions, with the plants arranged on a bench within a field of view of the camera. In some embodiments, the plants and camera are not necessarily stationary between images—e.g. plants may be rotated through the field of view of the camera so that one camera may image a larger number of plants.

### A System for Detecting Plants

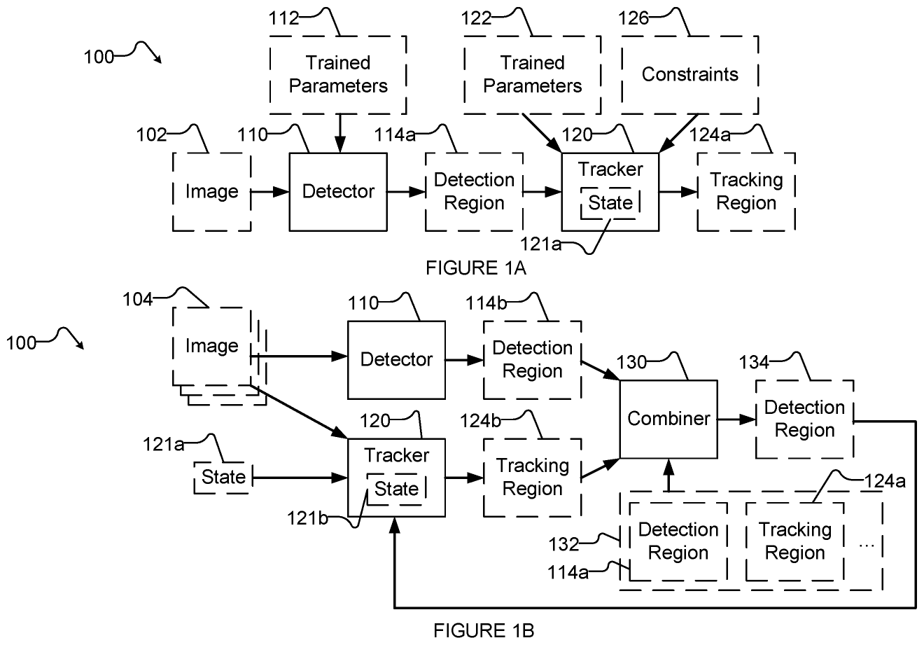

FIG. 1A and FIG. 1B (collectively and individually “FIG. 1”) show schematically an exemplary system 100 for detection of plants. System 100 comprises a computing system as described in greater detail elsewhere herein. FIG. 1A and FIG. 1B show interactions (as arrows) between elements of the system (shown in solid lines) in different modes of operation. System 100 may interact with various inputs and outputs (shown in dashed lines), which are not necessarily part of system 100, although in some embodiments some or all of these inputs and outputs are part of system 100 (e.g. in an example embodiment, trained parameters 112, 122 and/or constraints 126 are part of system 100).

FIG. 1A shows system 100 in a first mode of operation in which system 100 detects a plant in an image 102 and initializes a tracker 120 for that plant. In the depicted mode of operation, system 100 detects one or more plants in a first image 102 via detector 110. Detector 110 of system 110 comprises a machine learning model and may comprise a classifier such as a random forest, a neural network (e.g. a convolutional neural network), support vector machine, linear classifier, and/or any other suitable machine learning model.

Detector 110 may be associated with trained parameters 112 which define the operation of detector 110. Trained parameters may have been generated by training detector 110 over a set of training images, at least a subset of which share one or more characteristics with first image 102. For example, image 102 may comprise a near-infrared image of one or more plants, and trained parameters 102 may have been generated by training detector 110 over near-infrared images of plants. (Alternatively, or in addition, image 102 and the training images may comprise far-infrared images of plants, RGB images of plants, and/or any other suitable images of plants). Image 102 is an image in a sequence of images, which may comprise a sequence of still images (e.g. in JPG, BMP, PNG, and/or any other suitable format), one or more videos in which the sequence of images is encoded as frames (e.g. in AVI, H.264, MOV, and/or any other suitable format), and/or any other suitable representation of a sequence of images.

Detector 110 may generate a detection region 114a by, for example, transforming first image 102 based on trained parameters 112 into a detection region 114a. This transformation may comprise, for example, extracting a plant mask from first image 102 based on trained parameters 112, identifying one or more objects (e.g. plants, leaves, stems, etc.) in the plant mask, and extracting one or more detection regions 114a based on the one or more objects. For example, extracting the plant mask from first image 102 may comprise generating a predicted probability for each pixel of image 102 that the pixel is a plant, e.g. via random forest detector 110, and labelling each pixel as plant or non-plant (e.g. background) based on the predicted probability. As another example, identifying the one or more objects may comprise clustering the plant-labelled pixels based on a suitable clustering criterion. As another example, extracting one or more detection regions 114a may comprise extracting a bounding box around each object (e.g. each cluster of plant pixels). In some embodiments, detection region 114a comprises a bounding box, a predefined shape corresponding to the object (e.g. a circle, oval, square, rectangle, and/or other shape centered at the center of mass of the detected object and scaled to have corresponding area), an arbitrary shape corresponding to the object (e.g. the same shape as the object, the convex hull of the object), and/or any other suitable shape.

System 100 initializes a tracker 120 for a given plant based on a detection region 114a for that plant. Tracker 120 stores a memory of a location of the plant and updates it with successive images. The memory may comprise, for example, a state 121a of tracker 120 (which may, depending on the tracker 120, comprise tracking region 124a). Initializing tracker 120 may comprise, for example, generating a tracking region 124a based on detection region 114a (e.g. by transforming detection region 114a based on trained parameters 122 of tracker 120, by copying and/or referencing detection region 114a, and/or by otherwise performing a suitable initialization procedure for tracker 120) and optionally based on first image 102. Tracking region 124a may comprise any suitable form, and may correspond to and/or differ from detection region 110; for example, detection region 114a and tracking region 124a may each comprise bounding boxes (with the same or different dimensions and/or position) and/or any of the forms described above with respect to detection region 124a. Tracker 120 may update state 121a and/or tracking region 124a to generate further tracking regions based on subsequent images in the sequence of images. (“Subsequent” as used herein means that each image is followed by another image which is temporally adjacent, generally moving forward in time as one progresses through the sequence, although the sequence may optionally be arranged so that one moves backward in time, and/or so that the sequence is traversed in reverse, without departing from the spirit and scope of this specification or the appended claims).

Tracker 120 may comprise, for example, a region of interest tracker, such as a discriminative correlation filter with channel or spatial reliability tracker (CSRT), for instance as described by Lukežič, Alan et al. “Discriminative Correlation Filter Tracker with Channel and Spatial Reliability.” International Journal of Computer Vision 126.7 (2018): 671-688, arXiv:1611.08461v3 [cs.CV] 14 Jan. 2019. In embodiments where tracker 120 comprises a region of interest tracker, tracker 120 may alternatively, or in addition, comprise a kernelized correlation filter tracker (KCF), tracking-learning-detection tracker (TLD), and/or any other suitable region of interest tracker. In some embodiments, tracker 120 comprises a machine learning model which retains a memory between inputs, such as an object tracker comprising an LSTM, e.g. as described by Jiang, Ming-xin et al., “Multiobject Tracking in Videos Based on LSTM and Deep Reinforcement Learning”, Complexity, vol. 2018, Article ID 4695890, 12 pages, 2018. https://doi.org/10.1155/2018/4695890. Tracker 120 may additionally, or alternatively, comprise any other tracker suitable for tracking objects in a sequence of images.

In some embodiments, system 100 initializes one or more trackers 120 for each of one or more plants detected by detector 110. System 100 may optionally initialize one or more trackers 120 based on one or more constraints 126. For example, constraints 126 may comprise a number of plants n in image 102 and/or in the sequence of images. Such number of plants n may be predetermined, received from a user, retrieved from a datastore (e.g. over a network), and/or otherwise obtained by system 100. System 100 may initialize at most n trackers 120 (e.g. by enforcing that constraint 126 as a maximum number of trackers 120), at least n trackers 120 (e.g. by enforcing that constraint 126 as a minimum number of trackers 120), precisely n trackers 120 (e.g. by enforcing that constraint 126 as the number of trackers 120 to be initialized), and/or by otherwise initializing a number of trackers 120 based on the number of plants n in image 102 and/or the sequence of images as represented by constraints 126.

In some embodiments, system 100 initializes one or more trackers 120 based on first image 102, up the number of plants n as represented in constraints 126, and initializes further trackers 120 based on further images if further plants are detected, subject to the total number of trackers 120 being no more than the number of plants n represented by constraints 126. If system 100 generates more than n (i.e. at least n+1) detection regions 114a (and/or detection regions 114b, discussed below) based on the sequence of images, system 100 may select up to n of those detection regions and an initialize up to n trackers based on the selected detection regions.

In some embodiments, the up to n detection regions are selected by system 100 by determining, for each of the at least n+1 detection regions, an associated probability that the detection region contains a plant and selecting the up to n detection regions based on the associated probabilities. For example, if each pixel of image 102 has an associated probability (or confidence, or other suitable measure) of containing a plant, e.g. as represented by the plant mask, then each detection region may have an associated probability based on the maximum probability for any given pixel in the detection region, an average (geometric or arithmetic) of the probability for the pixels in the detection region, and/or a weighted average of the probabilities for the pixels (for instance, giving higher weights to pixels nearer to a center of the detection region than to pixels relatively farther away from that center). In some embodiments, such averaging or maximum-calculating may be determined based only on pixels labelled as plant in the plant mask (e.g. by excluding background pixels).

In some embodiments, the up to n detection regions are selected by system 100 by determining spectral characteristic values for some or all of the at least n+1 detection regions and rejecting some (and/or selecting others) based on a comparison of those spectral characteristic values between some or all of the at least n+1 detection regions. Each spectral characteristic value may estimate a similarity between a portion of an image corresponding to a given detection region and an image of a plant, one or more other detection regions, and/or one or more other suitable referents. For example, the spectral characteristic value may be based on a histogram distance between a given detection regions and one or more others of the at least n+1 detection regions. For instance, system 100 may determine a histogram distance between each pair of the n detection regions and, for each such detection region, may determine the average histogram distance between that detection region and other regions (e.g. each of the other n detection regions). The detection regions with the greatest average histogram distance may be regarded as being less likely to depict plants, as a larger average histogram distance may indicate, in suitable circumstances, a greater visual dissimilarity relative to other detection regions. System 100 may select the n detection regions with the lowest average histogram distances and reject the remainder.

FIG. 1B shows system 100 in a second mode of operation in which system 100 detects a plant in a second image 104 using both detector 110 and previously-initialized tracker 120 (e.g. initialized on first image 102 as shown in FIG. 1A). In the depicted mode of operation, system 100 detects one or more plants in a second image 104 via detector 110 and updates tracker 120 based on the current state of tracker 120. For the sake of example, and without loss of generality, let us assume that the immediately previous image was first image 102 and that, prior to updating tracker 120 based on second image 104, the state of tracker 120 in the illustrated second mode of operation is state 121a (which may comprise tracking region 124a and/or some other state, as appropriate). As will become apparent, the second mode of operation illustrated in FIG. 1B may pertain to any image in the sequence so long as a tracker 120 has been initialized (e.g. in some embodiments the second mode of operation may pertain to all images after the first).

Detector 110 may detect the one or more plants substantially as discussed with reference to FIG. 1A and/or as discussed elsewhere herein. Detector 110 generates a detection region 114b for each of the one or more plants.

Tracker 120 is updated by system 100 to generate a second tracking region 124b based on second image 104 and a state of tracker 120 based on first image 102. For example, in an embodiment where tracker 120 comprises a CSRT, system 100 may update a spatial reliability map and/or channel reliability weights of tracker 120 substantially as described by Lukežič (cited elsewhere herein) to generate second tracking region 124b.

A variety of challenges may arise with respect to detection regions 114b and tracking regions 124b. For example, if system 100 is tracking several plants, the correspondence between detection regions 114b and tracking regions 124b and/or plants may not be immediately evident. As another example, there may be different numbers of detection regions 114b and tracking region 124b. As yet another example, even when a correspondence between detection regions 114b and tracking regions 124b is known, detection regions 114b and tracking regions 124b may represent different predictions of the position of a given plant. Such challenges may be addressed by one or more optional elements of system 100. In FIG. 1B, exemplary combiner 130 is represented schematically as a single element which addresses one or more (e.g. all) of these challenges.

In some embodiments, combiner 130 matches detection regions 114b and tracking regions 124b based on a prediction of whether a given detection region 114b identifies the same plant as a given tracking region 124b (and/or vice-versa). In at least some embodiments, combiner 130 generates such a prediction based on an assumption that the plants are substantially stationary by generating the prediction based on temporal position information for the plant relating to other images in the sequence of images. Such temporal position information may be stored in a memory 132 comprising detection regions 114a, tracking regions 124a, and/or other information (e.g. state 121a) relating to the position of the plant in previously-processed images (such as, but not limited to, image 102).

For example, combiner 130 may match detection region 114b to a plant based on a similarity in position between detection region 114b with a region 114a, 124a for that plant for first image 102. Such matching may comprise, for example, associating regions 114a and/or 124a (and/or, optionally, an updated detection region for image 102, not shown; e.g. analogous to region 134, described below) while processing image 102 with an identifier for a plant, matching detection region 114b with such region 114, 124a, etc., and associating detection region 114b with the identifier for the plant. As another example, combiner 130 may match detection region 114b to tracking region 124b, which is itself based on tracking region 124a and thus comprises temporal position information for earlier image 102 (and which may, e.g., inherit the association of tracker 120 with a given plant).

System 100 may match regions 114b, 124b based on one or more criteria, such as matching each detection region 114b with another region (e.g. tracking region 124b and/or a region in memory 132 such as regions 114a and/or 124a for image 102 for which system 100 has previously determined an association with the plant of tracking region 124b) based on a proximity between such regions and/or another correspondence between such regions. For example, combiner 130 may match detection regions 114b to regions 114a, 124a, 124b, etc., based on a distance between centers of regions 114b and regions 114a, 124a, 124b, etc., such as by determining that centroids and/or centers of mass of such regions are less than a threshold distance apart and/or are less than a distance between centers of other pairs and/or sets of such regions.

As another example, combiner 130 may match detection regions 114b to tracking regions 124b based on an overlap between regions 114b and regions 114a, 124a, 124b, etc. As another example, combiner 130 may match detection regions 114b to tracking regions 124b, based on minimizing (or maximizing, as appropriate) an objective function, such as minimizing a sum of distances between matched regions (e.g. regions 114a, 114b, 124a, 124b, etc.) and/or maximizing a sum of overlapping areas between all matched regions. Combiner 130 may match detection regions 114b to tracking regions 124b, based on any other suitable correspondence criterion, including based on a correspondence between regions 114b and one or more of regions 114a, 124a, 124b, etc.

In some embodiments, if detection regions 114b are generated by detector 110 but are not matched to any tracking region 124b (which may occur, for example, if there are more detection regions 114b than tracking regions 124b and/or if some detection regions 114b do not sufficiently correspond to any tracking regions 124b) then system 100 may initialize another tracker 120 based on detection region 114b substantially as described with reference to FIG. 1A (subject to detection region 114b and image 104 taking the place of detection region 114a and image 102). Combiner 130 may determine that unmatched detection regions 114b remain and, by such determining, may cause system 100 to perform such initializing. System 100 may constrain the initialization of trackers 120 (including such newly-initialized tracker 120) not to exceed a given number of plants, e.g. as described with reference to FIG. 1A.

In at least some embodiments, combiner 130 combines one or more detection regions 114b with a matching tracking region 124b to update tracker 120. For example, such combining may comprise combining one or more detection regions 114b with matching tracking region 124 to generate an updated detection region 134 and updating tracker 120 to update state 121b of tracker 120 and/or to generate an updated tracking region (e.g. taking the place of tracking region 124b). System 100 may update tracker 120 in any suitable way, e.g. by re-initializing tracker 120 based on updated detection region 134 to generate a new state 121b, and/or by updating tracker 120 as described elsewhere herein.

In some embodiments, combining one or more detection regions 114b and tracking region 124b comprises determining a union and/or intersection of one or more detection regions 114b and tracking region 124b. In at least one embodiment, combiner 130 matches each tracking region 124b to at most one detection region 114b (and/or vice versa), with no detection region 114b matched to more than one tracking region 124b. Combiner 130 may generate, for each tracking region 124b with a matching detection region 114b, an updated detection region 134 by determining the union of each tracking region 124b with its matched detection region 114b. Combiner 130 causes system 100 to update tracker 120 based on updated detection region 134, e.g. by reinitializing tracker 120 based on updated detection region 134 and/or as described elsewhere herein.

One potential benefit of generating detection regions 110 and tracking regions 120 is that, when one technique provides unsatisfactory results (e.g. by failing to detect or track a plant for a given image), the other technique may not. Another potential benefit is that, in some circumstances, it is possible to make use of the substantially stationary nature of plants to enable each technique to bolster the other where appropriate, and/or to make use of temporal information (e.g. as stored in memory 132) when both techniques fail.

In some embodiments, combiner 130 selects at least one of the regions 114a, 124a, 114b, 124b, 134 and updates tracker 120 based on the selected region. In some embodiments, combiner 130 makes the selection based by validating one or more regions 114a, 124a, 114b, 124b, 134 and selecting from among the validated regions. In some embodiments combiner 130 combines two or more validated regions 114b, 124b to generate an updated detection region 134, validates updated detection region 134, selects at least one region 114b, 124b, 134 based on the validation, and causes system 100 to update tracker 120 based on the selected region.

Validation may comprise, for example, determining that regions 114b, 124b, and/or 134 represent a plant which has remained substantially stationary between images 102, 104. For example, combiner may determine that a region 114b, 124b, 134 is valid if combiner 130 determines that said region's center is sufficiently near to (e.g. within a threshold distance of) a previously-generated region for an earlier image such as regions 114a, 124a for first image 102. In some embodiments, invalid regions are discarded. In some embodiments, regions determined to be invalid may be rejected as matches for earlier regions, but may be used to initialize new trackers 120 (e.g. if constraints 126 allow for n plants but fewer than n trackers have been initialized), as described in greater detail elsewhere herein.

Validation may also, or alternatively, comprise determining that a region represents only one plant, rather than a plurality of plants, based on an assumption that the plants are substantially stationary. As plants grow, they may abut and/or occlude other plants, particularly if they are growing in close quarters, which can cause detectors (such as detector 110) to detect a plurality of plants as one larger plant, effectively “merging” the plants. For example, combiner 130 may determine that a region does not overlap a plurality of regions for other plants by more than a threshold area. “Overlap” includes, for example, corresponding pixels of images 102 and 104 (e.g. pixels at the same coordinate in their respective images, and/or pixels representing the same location in a scene, e.g. after adjusting for movement of the imaging device) being included in each of two regions. The threshold area may be any suitable amount; e.g. 10%, 20%, 30%, 40%, 50%, 60%, 70%, 80%, 90%, or any amount in between those values.

For instance, combiner 130 may determine that a given detection region 114b for image 104 overlaps at least 50% of the area (e.g. at least 50% of the pixels of the regions correspond) of a first detection region 114a for a first plant and a second detection region 114a for a second plant in image 102, and may reject such detection region 114b as invalid (as it is predicted to be likely to represent multiple plants). In some embodiments, combiner 130 generates new detection regions 114b for image 102 based on the overlapped regions (e.g. detection regions 114a in the earlier example), for instance by copying the overlapped regions (e.g. instantiating new detection regions 114b for image 104 corresponding to overlapped detection regions 114a for image 102). In some embodiments, combiner 130 increases a size of one or more of the copied overlapped regions based on a size of rejected detection region 114b; such increasing may comprise, for example, scaling up the overlapped regions: to meet a boundary of rejected detection region 114b, to comprise a combined area corresponding to rejected detection region 114b, to cause the overlapped regions to abut, and/or to increase in size in any other suitable way.

In some embodiments, combiner 130 may determine that more detection regions 114b have been generated than there are trackers 120 to match such detection regions 114b to. In some implementations, combiner 130 initializes one or more additional trackers for one or more of the detection regions 114b, e.g. as described elsewhere herein. In some implementations, combiner 130 may attempt to reduce the number of detection regions 114b by combining detection regions 114b if such regions are sufficiently near to each other (e.g. if centers of such regions 114b are within a threshold distance of each other, if such regions 114b overlap by at least a threshold, and/or if such regions correspond, e.g. as described elsewhere herein) and/or if such regions correspond to the same earlier detection region 114a and/or tracking region 124a (e.g. if such regions are nearest to the same earlier detection region 114a and/or tracking region 124b). In some embodiments, combiner 130 may discard one or more detection regions 114b (e.g. if centers of such regions 114b are more than a threshold distance from each other, which may be a different distance than may be used to determine correspondence, and/or if such regions 114b lack correspondence as described elsewhere herein).

In some embodiments, combiner 130 may determine that fewer detection regions 114b have been generated than there are trackers 120. In some implementations, combiner 130 may match detection regions 114b to a subset of tracking regions 124b (e.g. by matching each detection region 114b to the nearest detection region 114a and/or tracking region 124a, 124b based on proximity, as described above) and may, for given image (e.g. image 103) not generate an updated detection region 134 for updating those trackers 120 which are not matched to a detection region 114a. For example, tracking window 124b may be selected by combiner 130 as a prediction of a position of the plant associated with tracker 120 for image 104.

In some embodiments, combiner 130 determines that there are no valid detection regions 114b or tracking regions 124b for image 104 for a given plant. In some implementations, combiner 130 selects a region 114a, 124a, and/or a previously-generated updated detection region (not pictured; e.g. this may be analogous to region 134) generated for a previously-processed image (e.g. image 102). Combiner may adopt the selected region as a prediction for a position of the plant, and may optionally update tracker 120 based on the selected region.

System 100 (e.g. at combiner 130) may select a region to provide as output to predict the position of the plant in image 104. The selected region may comprise detection region 114b, tracking region 124b (as updated by combiner 130, where appropriate), updated detection region 134, and/or a region (e.g. regions 114a, 124a) for an earlier image 102 for the plant. For example, system 100 may validate each of detection region 114b, tracking region 124b (as originally generated and/or as updated by combiner 130), and/or updated detection region 124b, and may select one based on, for example, a predetermined priority. For instance, selecting based on a predetermined priority may comprise selecting tracking region 124b as updated by combiner 130 if valid, otherwise updated detection region 134 if valid, otherwise tracking region 124b as originally generated if valid, otherwise detection region 114b if valid, otherwise the region selected for the plant in the immediately preceding image (e.g. region 114a, 124a, and/or another region of image 102).

System 100 may extract the plant from region 124a, 124b, and/or 134 (as appropriate) for one or more images of the sequence of images. For example, system 100 may generate an output sequence of images, each image of which comprises the pixels of a region 124a, 124b, and/or 134 (as appropriate) from the source sequence of images from which such regions were generated. The output sequence of images may then be used by system 100, another system, and/or any suitable user to monitor the plant in a format which, in suitable circumstances, is likely to be substantially isolated from other plants in the source sequence of images. Such an output sequence of images for a given plant may be used as, for example, training, validation, or test data for a machine learning model, such as a machine learning model for predicting disease progression. Such machine learning models may benefit from the separation of plants' extracted images into separate sequences, particularly if the machine learning models are trained over images of individual plants but are deployed at scale in a context where an image may depict a plurality of plants (e.g. 2, 10, 100, 1000, 10,000, 100,000, 1,000,000, and/or a number between or greater than these).

### A Method for Detecting Plants

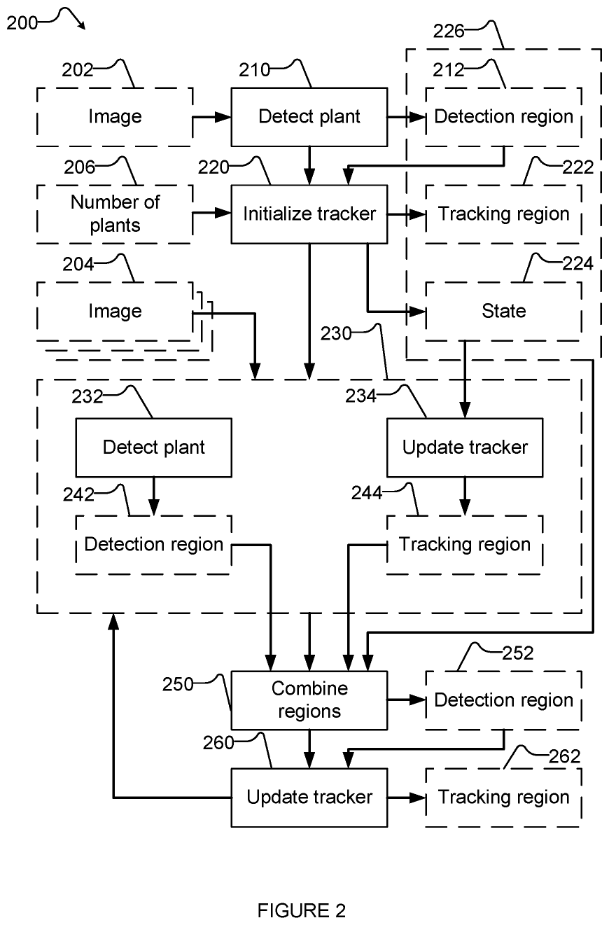

FIG. 2 shows a flowchart for an exemplary method 200 for detection of plants. Method 200 may be performed by system 100 and/or any suitable computing system. At act 210 the system detects one or more plants in a first image 202 of a sequence of images to generate a detection region 212 for at least one of the one or more plants, e.g. as described above with respect to detector 110 detecting one or more plants in image 102 of FIG. 1. For example, detecting one or more plants may comprise performing inference with a machine learning model for detecting plants based on trained parameters of that model to generate a plant mask which maps regions (e.g. groups of one or more pixels) of first image 202 to probabilities that the regions include a plant, identifying one or more objects in image 202 based on the plant mask (e.g. by clustering regions labelled as plant), and generating one or more detection regions 202 for the one or more plants based on at the one or more objects in the plant mask (e.g. by drawing a bounding box around an object). Other detection techniques may alternatively, or additionally, be used if suitable.

At act 220 the system initializes one or more trackers for the one or more plants detected at act 210 based on the one or more detection regions 212. In particular, the system initializes at least a first tracker comprising a first state 224 and generating a first tracking region 222 for at least a first plant of the one or more plants based on a first detection region 212, e.g. as described above with respect to tracker 120 of FIG. 1. For example, the system may initialize a CSRT tracker for the first plant based on detection region 212 to generate tracking region 222. Such a CSRT tracker may, for example, comprise a state 224 comprising a spatial reliability map for restricting tracking regions 124a generated by the CSRT tracker to regions of first image 202 suitable for tracking (e.g. plant-labelled pixels) and channel reliability weights for weighting per-channel responses of a filter of the CSRT tracker in localization. (“First” is used herein to distinguish certain referents from others, and not necessarily to specify that such referents are temporally introduced before any others. Like terms, such as “second”, are used analogously.) Method 300 may make use of detection region 212, tracking region 222, state 224, and/or other information relating to image 202 (and/or to images processed prior to image 202) in act 230 and later acts, and may comprise storing such information as memory 226.

In some embodiments, act 220 comprises constraining initialization of trackers based on one or more constraints, such as constraint 206. Constraint 206 comprises a number of plants n and act 220 may comprise constraining the number of trackers initialized based on the number of plants n as described elsewhere herein.

At act 230 the system detects one or more plants, including the first plant, in a second image 204 of the sequence of images. Second image 204 may depict the same one or more plants as in image 202, may depict additional plants relative to image 202 (e.g. if an additional plant has been added to the camera's field of view), and/or may lack depiction of one or some of the one or more plants relative to image 202 (e.g. if a plant has been removed, which may occur due to death, treatments, completed growth, replanting, and/or other reasons). Act 230 may comprise multiple acts for identifying plants in image 204. In the depicted, exemplary embodiment of FIG. 2, act 230 comprises acts 232 and 234. At act 232, the system detects one or more plants to generate one or more detection regions 242 based on second image 204, e.g. as described above with respect to act 210. At act 234, the system updates one, some, or all of the trackers initialized at act 220 based on image 204 and the trackers' corresponding states 224 to generate second tracking regions 244. Act 234 comprises, for instance, updating the state 224 of the first tracker and causing the first tracker to generate a second tracking region 244 for the first plant (which is associated with the first tracker). Updating the first tracker (and/or any other trackers) may be performed as described above with reference to FIG. 1B and/or as elsewhere described herein.

Act 232 is optional and may be omitted for one, some, or all images subsequent to a given first image 202. For example, act 232 may be performed for every k^{th} image, e.g. to periodically add information tracking regions 244. As another example, act 232 may be performed for no images subsequent to first image 202 within a given sequence of images. For instance, detection region 212 may be used to initialize one or more trackers in image 202 and plants may be detected in subsequent images (e.g. image 204) solely by the one or more trackers. Output in such embodiments may be based on tracking region 244 without necessarily involving a further detection region 242. For example, the system may provide tracking region 244 as output, and/or may generate a detection region as output based on tracking region 244 (e.g. by transforming tracking region 244 into a bounding box).

In some embodiments, at act 250 the system combines one or more detection regions 242 for the one or more plants (e.g. detection regions 242 which are predicted to contain the one or more plants) with second tracking regions 244 for the one or more plants to generate, for at least one of the one or more plants, an updated detection region 252. Such combining may comprise the acts described, for example, with respect to FIG. 1B (e.g. with respect to combiner 130 and updated detection region 134). For instance, a second detection region 242 and a second tracking region 244 for the first plant may be combined by matching said detection region 242 with a detection region 212 and/or a tracking region 222 for the first plant based on proximity between centers of said regions 242, 212, 222 and generating updated second detection region 252 for the first plant based on a union of regions 242, 244. Detection and tracking regions 242, 244 may be matched and combined for any number of plants, depending on the embodiment and whether criteria for such combination (e.g. sufficient overlap) are met.

In some embodiments, at act 260 the system updates one or more trackers based on one or more updated second detection regions 252. Updating one or more trackers at act 260 may comprise, for example, reinitializing trackers substantially as described at act 220 based on detection regions 252, updating trackers substantially as described at act 234 based on detection regions 252, and/or as otherwise suitable for a given tracker. (Reinitialization of a tracker may comprise generating a new state for a tracker based on a detection region 252.) Trackers having tracking regions 244 for which no detection regions 242 were matched may be omitted from the updating of act 260 (which, in some circumstances, may mean that no trackers are updated at act 260 for a given image 204).

Acts 250 and 260 are optional. For example, in embodiments or circumstances where no detection region 242 is not generated, acts 250 and 260 may be omitted. As another example, even where an updated second detection region 252 is generated at act 250, act 260 may be omitted, thereby allowing updated detection regions 252 to be generated without necessarily updating trackers based on detection regions 242, 252.

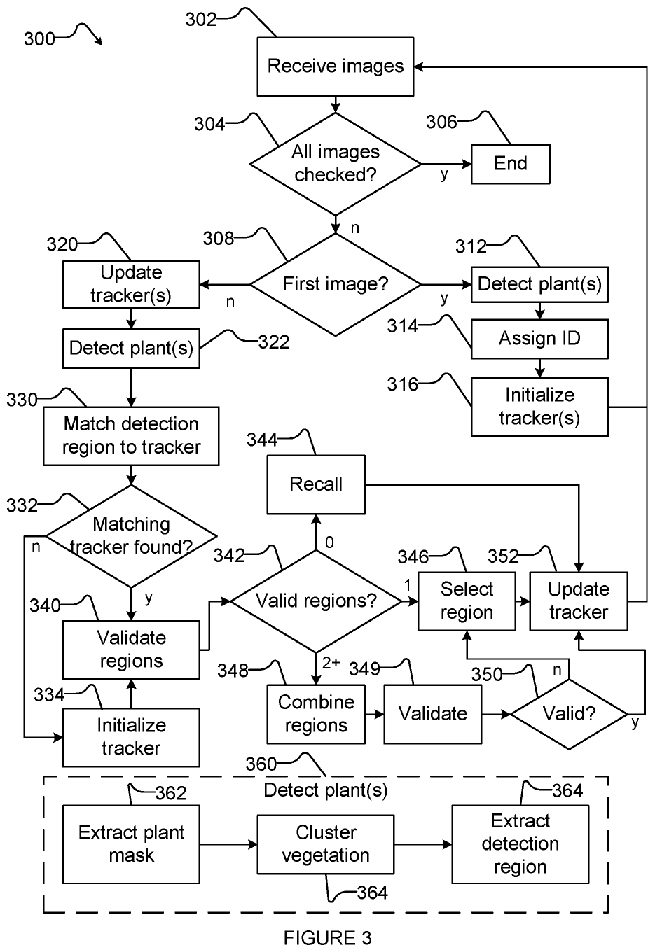

In some embodiments, following act 260 (or, if such act is omitted, following another act, such as acts 234, 250), method 200 returns to act 230 to process a further image (e.g. a third image of the sequence of images) substantially as described above. Memory 226 may be updated to comprise detection regions 242 and/or 252, tracking regions 244 and/or 262, and/or states of trackers; updating may comprise replacing corresponding items of memory 226 with updated items, appending updated items and preserving existing items of memory 226, and/or otherwise updating memory 226. Memory 226, as updated, may be used in subsequent iterations of act 230. In some embodiments, where act 230 generates a detection region 242 for which no tracking region 244 is combined at act 250, method 200 may return to act 220 and initialize a tracker to generate a tracking region 222 based on unmatched detection region 242. Thus, initialization of trackers at second image 204 and subsequent images is permitted, although this control flow is omitted from FIG. 2 for readability. (An example implementation which includes such a flow is shown in FIG. 3, below.)

### Example Method Implementation

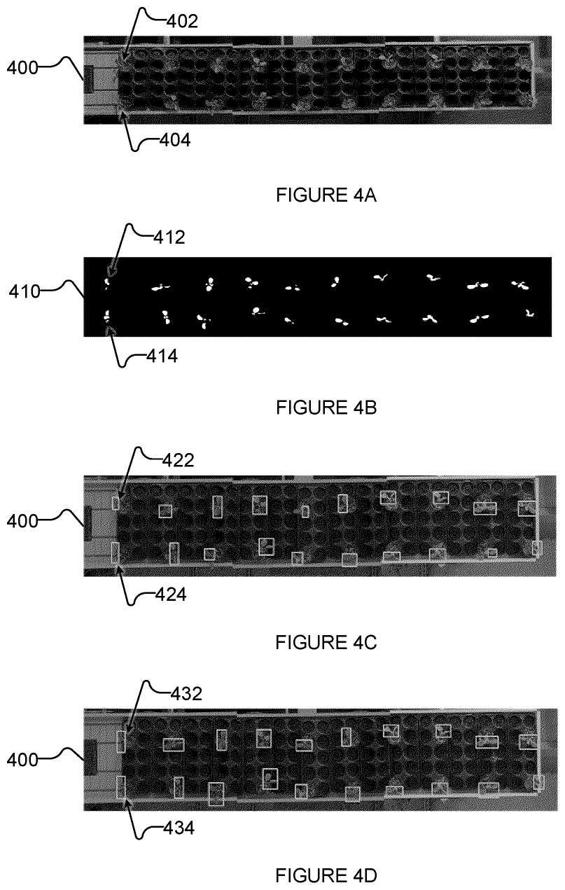

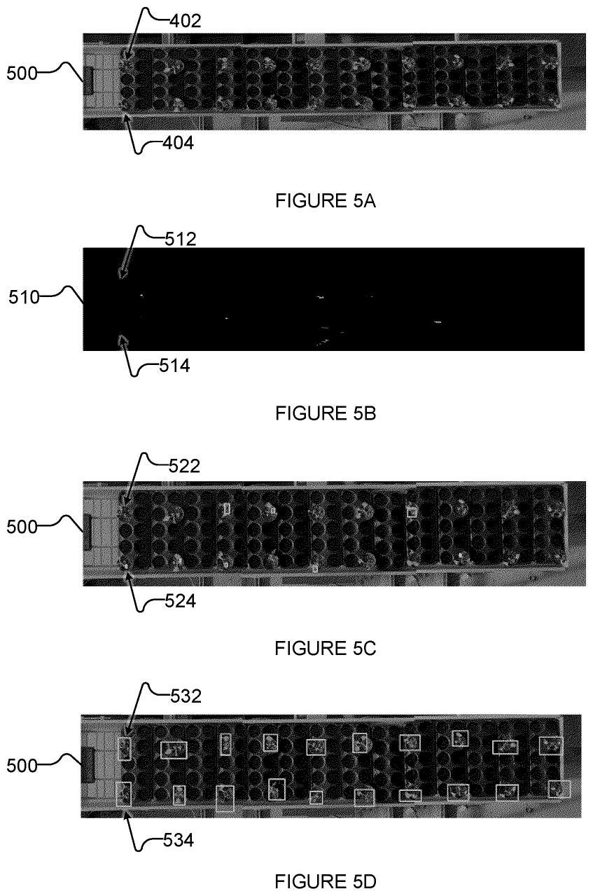

FIG. 3 shows a flowchart for an exemplary method 300 for detection of plants, which is an exemplary implementation of method 200. Method 300 may be performed by system 100 and/or any suitable computing system. The following discussion of method 300 is supplemented by discussion of FIGS. 4A, 4B, 4C, and 4D (collectively and individually “FIG. 4”) and FIGS. 5A, 5B, 5C, and 5D (collectively and individually “FIG. 5”), which show images input to an example implementation of method 300 and show output of the same example implementation. In particular, FIG. 4A shows an example first image 400 of a sequence of images representing several plants, including plants 402, 404, and FIG. 5A shows an example second image 500 showing the same plants at different respective stages of growth and, in some cases, disease progression. In the example trial in which these images were captured, first image 400 was the 1^{st} image captured (on the 1^{st} day) and second image 500 was the 14^{th} image captured (on the 6^{th} day). As can be seen in FIG. 5A, several of the plants exhibit significant disease progression by the sixth day of this example's trial (i.e. by the time image 500 was captured). FIGS. 4 and 5 are described in greater detail below alongside discussion of method 300 to illustrate an exemplary implementation of method 300 and are not intended to limit the scope of method 300 or any other system or method in the specification or the appended claims.

Returning to method 300, at act 310, the system receives a sequence of images (which may be a subsequence of a larger sequence). Act 310 may comprise, for example, accessing one or more images of the sequence of images from a memory, a storage device, another system, or any other suitable data store. Method 300 proceeds with a first image from the sequence, which in some embodiments is the temporally-first image (e.g. the image with a timestamp earlier than all other images in the sequence and/or the image at the start of a temporally-sorted sequence). For instance, in the exemplary implementation of FIGS. 4 and 5, method 300 proceeds with processing first image 400. At act 304, the system determines whether all images of the sequence have been processed by method 300. If yes, method 300 terminates at act 306. Otherwise, the system determines whether the image currently being processed is the first image in the sequence at act 308. If the image currently being processed is determined to be the first image in the sequence at act 308, method 300 proceeds to act 312.

Act 312 comprises detecting one or more plants, e.g. as described with reference to combiner 130 (of FIG. 1) and/or acts 210, 232 (of FIG. 2). In at least the depicted exemplary embodiment, act 312 comprises the acts of inset 360. In such embodiments, act 312 comprises extracting a plant mask at act 362, clustering plants in the plant mask at act 364, and extracting detection regions based on the plants identified by clustering at act 366. For instance, in the example of FIGS. 4 and 5, act 312 comprised detecting one or more plants (e.g. first plant 402 and second plant 404) in image 400 by generating detection regions (such as detection region 422 for first plant 402 and detection region 424 for second plant 404) as shown in FIG. 4C.

Act 362 may comprise, for example, predicting for each pixel in the currently-processed image a label of “plant” or “background” (optionally, alternative and/or additional labels may be predicted) based on the trained parameters of a machine learning model for detecting plants. In an exemplary embodiment, the machine learning model comprises a random forest with trained parameters trained on a training dataset comprising near-infrared images, far-infrared images, and RGB images, and predicting labels for pixels comprises performing inference on the image with the machine learning model by transforming the image based on the trained parameters (and hyperparameters, such as those defining the model's structure) to generate the labels. For instance, in the exemplary implementation of FIGS. 4 and 5, FIG. 4B shows a mask 410 for image 400 and FIG. 5B shows a mask 510 for image 500, each comprising plant-labelled pixels (white) and background pixels (black). In the depicted example, changes in colouration and morphology of the plants between images 400 and 500 have resulted in less readily discernable labelling of the plants in plant mask 510 relative to plant mask 410.

In some embodiments, act 362 comprises extracting a background mask based on the trained parameters of the machine learning model. The background mask labels pixels of the image as background or not-background (e.g. by labelling each pixel with a predicted probability that the region includes non-plant background). In some embodiments, act 362 comprises generating the plant mask by inverting the background mask. Experimental results indicate that, for certain machine learning models (e.g. certain machine vision models pretrained on large datasets comprising many images not necessarily restricted to plants) that labelling background can have greater accuracy than labelling plants, yielding a more accurate plant mask after inversion.

Act 364 may comprise, for example, any suitable clustering technique, such as centroid-based clustering, density-based clustering, distribution-based clustering, and/or other clustering techniques. One may regard each such clustered object as a predicted plant; it should be noted that such predictions are not necessarily error-free, and that inaccurately identifying a plant does not bring a machine learning model outside of the scope of the present specification or claims. For instance, in the exemplary implementation of FIG. 4, the pixels referred to generally as 412 relate to a first plant and may be clustered as one object, and the pixels referred to generally as 414 relate to a second plant and may be clustered as another object. In the exemplary implementation of FIG. 5, the pixels referred to generally as 512 relate to the first plant and may be clustered as one object, and the pixels referred to generally as 514 relate to the second plant and may be clustered as another object. Further clusters (not specifically identified to maintain readability) may be identified for further plants in each image 400, 500 and each mask 410, 510. The less readily discernable labelling of the plants in plant mask 510 relative to plant mask 410 may result (and, in the depicted example, does result) in fewer clusters being determined (i.e. some plants are missed) in mask 510 relative to mask 410 and clusters generally being smaller, sometimes omitting portions of the plants, in mask 510 relative to mask 410.

Act 366 may comprise, for example, extracting a detection region for each plant by generating a bounding box around each predicted plant (i.e. clustered object). For instance, in the exemplary implementation of FIG. 4, detection region 422 comprises a bounding box drawn around plant-labelled pixels 412 of mask 410 corresponding to the first plant and detection region 424 comprises a bounding box drawn around plant-labelled pixels 414 of mask 410 corresponding to the second plant. In the exemplary implementation of FIG. 5, detection region 522 comprises a bounding box drawn around plant-labelled pixels 512 of mask 510 corresponding to the first plant and detection region 524 comprises a bounding box drawn around plant-labelled pixels 514 of mask 510 corresponding to the second plant. As can be seen in FIGS. 4C and 5C, accuracy of detection has degraded over time in the example of FIGS. 4 and 5. The less reliable detection of plants and the resulting clustering of pixels for image 500 (relative to image 400) have resulted in the first plant lacking a detection region in FIG. 5C (indicated by the absence of a detection region depicted at the locationally identified generally as 522) and detection region 524 for the second plant omitting substantial portions of the second plant in FIG. 5C. In contrast, detection regions 422 and 424 in FIG. 4C fairly accurately bound the first and second plants, respectively.

Looking ahead to FIGS. 4D and 5D, these figures depict images 400 and 500 respectively with selected regions (i.e. detection regions and/or tracking regions, as discussed in greater detail with reference to act 346 and elsewhere herein), namely selected regions 432 and 434 for the first and second plants, respectively, in FIG. 4D and selected regions 532 and 534 for the first and second plants, respectively, in FIG. 5D. In at least the depicted example, the various depicted selected regions more accurately correspond to the positions of their corresponding plants in image 500 than do the detection regions of FIG. 5C. Discussion now returns to the body of FIG. 3 to describe how such results were obtained at least in the exemplary embodiment of FIGS. 4 and 5 and how to perform such methods more generally.

Method 300 proceeds from act 312 to act 314 and optionally assigns an identifier for each plant, which may be unique to the plant. Optionally, if the number of plants n is known in advance (e.g. via a constraint such as constraint 206) then the number of plants identified is limited to n. At act 316 the system initializes a tracker with an associated tracking region for each identified plant, e.g. as described elsewhere herein. In at least an exemplary embodiment, act 316 comprises initializing, for each plant, a CSRT tracker based on the detection region for the plant generated at act 312 (e.g. at act 366), such that the CSRT tracker generates a tracking region based on a spatial reliability map of the CSRT tracker, the spatial reliability map (and thus the tracking region) based on the detection region for the plant and/or the portion of the plant mask to which the detection region relates.

In at least some embodiments, the identifier assigned at act 314 is associated with the tracker initialized at act 316, such that tracking regions for one, some, or all of the images in the sequences for a given plant are associated with the identifier. The tracker can thus enable consistent identification of the plant over time (consistent relative to conventional detection techniques, for at least some of which consistent identification can be challenging). Enabling such consistent identification as described herein can assist with assessing the plant's growth, disease progression, and/or other changes over time, can assist with extracting images of a specific plant to be used as training data for other machine learning models and/or as input to other systems and/or methods, and/or can assist with other applications for which images of a specific plant over time are desired.

Having identified plants in the first image, method 300 may proceed to act 302 (as depicted) to receive one or more further images from the sequence of images, and/or to act 304 (e.g. if the next image for processing has previously been received). Acts 304 and (if appropriate) 308 are repeated for the next image. For the one or more further images, method 300 proceeds from act 308 to act 320.

At act 320, the system updates the one or more trackers based on the currently-processed image to generate new tracking regions, e.g. as described with reference to acts 234, 260 of FIG. 2. At act 322, the system detects one or more plants in the currently-processed image to generate new detection regions based on the currently-processed image, e.g. as described with reference to act 312. Acts 320 and 322 may be performed in any order, including in parallel (in whole or in part). For example, in the example of FIGS. 4 and 5, act 320 may comprise updating the one or more trackers based on image 500 (optionally after having performed one or more of acts 320-352 for one or more images sequentially between images 400 and 500) and act 322 may comprise generating the detection regions of FIG. 5C (e.g. detection region 524) based on image 500.

At act 330 the system attempts to match the one or more detection regions generated at act 322 with the one or more trackers (e.g. by matching the detection regions to tracking regions of such trackers and/or to detection regions previously matched with such trackers), e.g. as described with respect to act 250 of FIG. 2. For example, an unmatched detection region (e.g. a bounding box) may be matched to a tracker with a tracking region for a previous image (e.g. image 400 or another image in the sequence of images) which has a center (e.g. center of mass) that is within a threshold distance of a center of the unmatched detection region, and/or for which such distance between centers is less than the distance between the center of the unmatched detection region and any other tracking region. In some embodiments, the detection region is matched to the tracking region (if any) having the greatest overlap with the detection region. In some embodiments, the detection region is matched only to a tracker which has not previously been matched to another detection region for the currently-processed image. In some embodiments, once matched, a detection region may be associated with a plant identifier associated with the region to which the detection region is matched, thereby matching the detection region with a tracker also associated with the plant identifier and facilitating extraction of images of the plant associated with the plant identifier.

At act 332, the system determines whether the detection region was successfully matched to a tracker. If not, a new tracker may be initialized at act 334 based on the detection region (e.g. as described with respect to act 316). In at least an exemplary embodiment, a new tracker is only initialized at 334 if the total number of trackers has not yet reached the number of plants n provided by a constraint. Method 300 may match detection regions to trackers at act 330, test matches at act 332, and/or initialize trackers at act 334 in sequence, in parallel, and/or as may otherwise be suitable. In some embodiments, method 300 involves performing such acts (as appropriate) for all relevant regions prior to validating regions at act 340.

At act 340, method 300 comprises validating detection regions and/or tracking regions, e.g. as described elsewhere herein. For example, the system may determine whether a region overlaps with detection regions (and/or more tracking regions) for a prior image (e.g. image 400) associated with more than one plant by more than a threshold overlap area. In at least an exemplary embodiment, the threshold overlap area is 50%; in such an embodiment, the region may be determined to be invalid if at least 50% of the region overlaps with two detection regions (excluding detection regions generated for the same clusters) and/or two tracking regions (excluding tracking regions generated by the same tracker) for a prior image. In some embodiments, the region may be invalidated if it overlaps sufficiently with multiple detection regions and/or tracking regions for different plants across a plurality of images (e.g. by overlapping sufficiently with a detection region for a first plant in one image and a tracking region for a second plant in another image). In some embodiments, if no invalidation criterion is met, the region may be determined to be valid.

Entering act 342, each plant is associated with a potentially-variable number of valid regions. For example, a plant may be associated with neither a valid tracking region nor a valid detection region, in which case method 300 proceeds to act 344. At act 344, in at least the depicted example embodiment, method 300 involves determining a prediction of the plant's position based on a previously-generated region for the plant. For example, act 344 may comprise selecting a detection region (or tracking region) for the plant generated at a previously-processed image, such as an output region for that plant in the immediately preceding image, and providing the selected image as an output region for the image currently being processed.

Returning to act 342, a plant may be associated with only one valid region, in which case method 300 proceeds to act 346. Act 346 comprises selecting the valid region (e.g. selecting the detection region if that is the valid region or selecting the tracking region if that is the valid region) and, if appropriate, updating the tracker for the plant based on the selected region at act 352. (Where the selected region is a tracking region generated based on the current state of the tracker, act 352 may be omitted/skipped.)

Returning to act 342, a plant may be associated with more than one valid regions, in which case method 300 proceeds to act 348. Act 348 comprises combining the valid regions to generate a combined region, e.g. as described with respect to generating updated detection region 134 of FIG. 1B. Such combination may comprise, for example, determining a union of the valid regions (e.g. a valid detection region and a valid tracking region) for the plant. Optionally, at act 349, the system determines whether the combined region is valid, e.g. as described with reference to act 342. At act 350, method 300 proceeds to act 352 if the combined region is valid and, at act 352, updates the corresponding plant's tracker based on the combined region (e.g. by reinitializing the tracker based on the combined region, and/or as otherwise as described herein). Method 300 proceeds from act 350 to act 346 if the combined region is not valid, in which case act 346 comprises selecting a region from among the valid regions. In at least one embodiment, act 346 comprises selecting the tracking region (i.e. giving priority to valid tracking regions over valid detection regions).

The region selected at 346, or the combined region validated at 350, or the region selected as an output region at act 344, may be provided by a system implementing method 300 as an output region for a given plant for the currently-processed image. In the case of an image processed at acts 312-316, the output region may comprise either the detection region or tracking region for the plant (which in some implementations may be identical and in other implementations may be different, e.g. depending on the tracker). In at least one embodiment, the tracking region generated at 316 is used if one is successfully generated (note that some trackers have failure states), and the detection region generated at 312 is used otherwise. For example, turning to FIGS. 4 and 5, output regions 432 and 434 for plants 402 and 404, respectively, comprise tracking regions generated at act 316. Output region 532 comprises a tracking region generated for first plant 402 based on image 500 at act 320, and output region 534 comprises a tracking region for plant 404 generated based on image 500 and detection region 524 at act 352 (in this instance, based on a reinitialization of the relevant tracker based on a combined region generated at act 348).

Method 300 proceeds from act 352 (and/or from another act, such as act 344 and/or 346 if act 352 is omitted/skipped) to process further images (e.g. one or more images subsequent to image 500 in the sequence of images) or to terminate, as appropriate. In some embodiments method 300 proceeds from act 352 to act 302 to receive further images; in some embodiments method 300 alternatively, or additionally (where appropriate), proceeds directly to act 304, 306, 308, 320, and/or any other suitable act.

### Example System Implementation

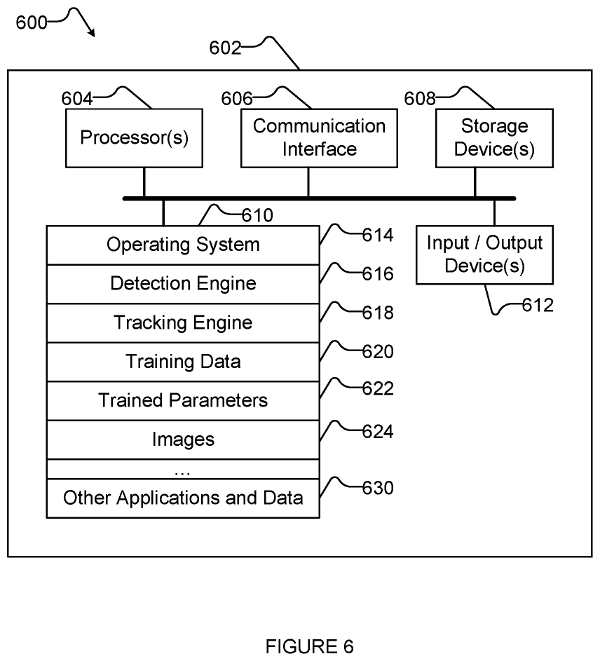

FIG. 6 illustrates a first exemplary operating environment 600 that includes at least one computing system 602 for performing methods described herein. System 602 may be any suitable type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. System 602 may be configured in a network environment, a distributed environment, a multi-processor environment, and/or a stand-alone computing device having access to remote or local storage devices.

A computing system 602 may include one or more processors 604, a communication interface 606, one or more storage devices 608, one or more input and output devices 612, and a memory 610. A processor 604 may be any commercially available or customized processor and may include dual microprocessors and multi-processor architectures. The communication interface 606 facilitates wired or wireless communications between the computing system 602 and other devices. A storage device 608 may be a computer-readable medium that does not contain propagating signals, such as modulated data signals transmitted through a carrier wave. Examples of a storage device 608 include without limitation RAM, ROM, EEPROM, flash memory or other memory technology, CD-ROM, digital versatile disks (DVD), or other optical storage, magnetic cassettes, magnetic tape, magnetic disk storage. In at least some embodiments such embodiments of storage device 608 do not contain propagating signals, such as modulated data signals transmitted through a carrier wave. There may be multiple storage devices 608 in the computing system 602. The input/output devices 612 may include a keyboard, mouse, pen, voice input device, touch input device, display, speakers, printers, etc., and any combination thereof.

The memory 610 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. The memory 610 may also include one or more external storage devices or remotely located storage devices that do not pertain to propagated signals, such as modulated data signals transmitted through a carrier wave.

The memory 610 may contain instructions, components, and data. A component is a software program that performs a specific function and is otherwise known as a module, program, engine, and/or application. The memory 610 may include an operating system 614, a detection engine 616, a tracking engine 618, training data 620, trained parameters 622, one or more images 624 (e.g. a time-series of images and/or a portion thereof), and other applications and data 630. Depending on the embodiment, some such elements may be wholly or partially omitted. For example, an embodiment intended for inference and which has trained parameters 622 might omit training data 620. As another example, memory 610 may include no images 624 prior to starting inference (e.g. via method 200 and/or method 300) and may receive images (one-by-one, in batches, and/or as a complete time-series) via an input device 612 and/or from a storage device 608.

### Example Application—Plant Health Indicators

In some embodiments the plants identified by system 100 and/or via methods 200, 300 are used to estimate an indicator of plant health. For example, in some embodiments system 100, or another system, estimates an indicator of plant health based on an output region (e.g. region 124a, 124b, 134, 222, 244, 252, 262, 532, and/or 534, as appropriate). For instance, system 100 (and/or another system) may estimate, for a given plant, a diameter, biomass, height, and/or other indicator of health for that plant based on an extracted image.

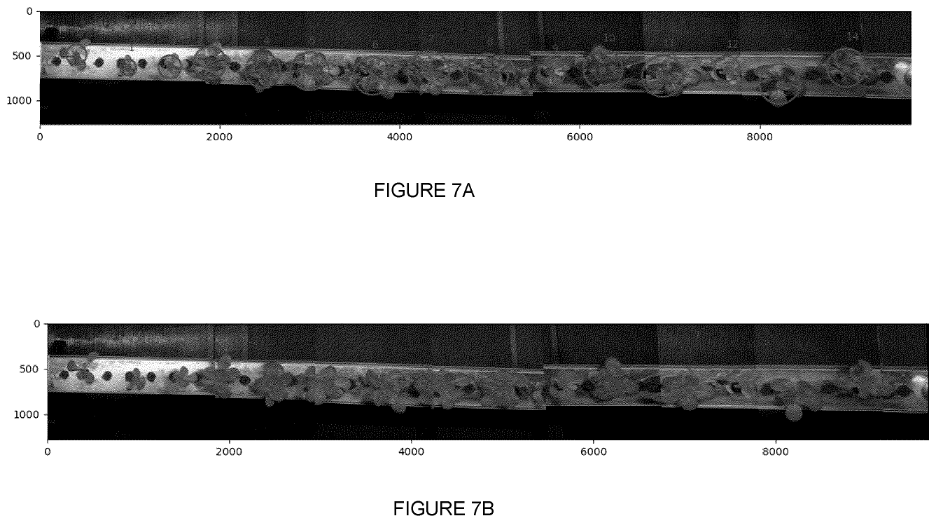

In some embodiments, a diameter of the plant is estimated based on an output region corresponding to the plant. In at least one embodiment, such diameter is estimated by fitting a circle to the plant based on an output region for that plant. Such estimating may comprise, for example, fitting a circle to the output region and/or segmenting the plant (e.g. by labelling pixels as plant or background) within the output region and fitting a circle to the plant-labelled pixels, e.g. as shown in FIG. 7A (fitted circles shown in red, with lower-diameter plants along the far left and higher-diameter plants towards the middle of the row). The diameter of the plant may be estimated based on the diameter of the fitted circle. The diameter may be expressed in any suitable units, such as pixels, cm, inches, etc. The system may determine an estimated diameter in cm, inches, or another physical measure by determining the diameter in units of pixels and determining the estimated diameter based on a distance per pixel, which may be predetermined, provided by a user, determined by the system (e.g. based on a reference card captured in an image) and/or obtained in any other suitable way. In at least one embodiment, such diameter is estimated by providing an image (e.g. corresponding to the output region, such as an extracted image cropped to conform to the output region) to a trained model. The trained model may be trained at least in part over images of plants labelled with diameters (in any suitable unit, e.g. cm) to provide an estimate of a diameter of an input plant. For instance, the trained model may comprise a convolutional neural network with a linearizing output layer.

In some embodiments, a biomass of the plant is estimated based on an output region corresponding to the plant. In at least one embodiment, such biomass is estimated by segmenting the plant (e.g. by labelling pixels as plant or background) within the output region to produce a segmentation mask and determining an estimate of biomass based on the segmentation mask, e.g. as shown in FIG. 7B (plant-labelled pixels shown in red, with lower-biomass plants along the far left and higher-biomass plants towards the middle of the row). In some embodiments, the estimate of biomass may comprise a proxy measure, such as an area of the plant. For example, an area of the plant may be estimated based on the segmentation mask, e.g. based on a number of plant-labelled pixels from the segmentation mask. For instance, the plant-labelled pixels may be summed together and multiplied by a per-pixel area (e.g. 0.1 cm²/pixel) to yield an estimated area of the plant in any suitable units (e.g. cm²). In some embodiments, the estimate of biomass comprises a mass and/or weight of the plant in any suitable units (e.g. kg, g, lb, oz). Such an estimate of biomass may be determined based on an estimated area (e.g. determined as described above) and/or by any other suitable approach. In at least one embodiment, such biomass is estimated by providing an image (e.g. corresponding to the output region, such as an extracted image cropped to conform to the output region) to a trained model. The trained model may be trained at least in part over images of plants labelled with biomass values (in any suitable unit, e.g. mass/weight units such as kg, g, lb, oz and/or area units such as cm²) to provide an estimate of a biomass of an input plant. For instance, the trained model may comprise a convolutional neural network with a linearizing output layer.

In some embodiments, a height of the plant is estimated based on an output region corresponding to the plant. In at least one embodiment, such height is estimated by providing an image (e.g. corresponding to the output region, such as an extracted image cropped to conform to the output region) to a trained model. The trained model may be trained at least in part over training images of plants labelled with height values (in any suitable unit, e.g. cm) to provide an estimate of a height of an input plant. For instance, the trained model may comprise a convolutional neural network with a linearizing output layer. Some or all of the training images may optionally be further labelled with depth information, such as a distance from the imaging sensor to a reference (e.g. the base of the plant, the ground, a support supporting the plant, a surface of a pot in which the plant is planted, etc.), a focal length of an optical system through which the imaging device acquires images, and/or other information. In some embodiments, e.g. embodiments where training images are not labelled with such depth information, the depth characteristics of the training images (e.g. distance to the plant, focal length) are substantially similar or identical to the depth characteristics of the images acquired in use. In some embodiments, the trained model is trained to generate a three-dimensional reconstruction of the plant and an estimate of a height of the plant is determined based on the three-dimensional reconstruction. In some embodiments, the trained model is trained based on stereoscopic images of plants. For example, the training images may be monoscopic images labeled based on height values determined based on stereoscopic images. (Such height values may be predetermined, determined by system 100, determined by another system, determined by a user, or otherwise determined.) As another example, the training images may comprise stereoscopic images; images acquired in use may also be stereoscopic. In some embodiments, a height of a plant is estimated geometrically based on stereoscopic images of the plant, e.g. by stereo vision, triangulation, disparity mapping, and/or any other suitable approach.

In some embodiments, an indicator of health for a plant (e.g. diameter, biomass, height, and/or another indicator) is estimated by a machine learning model trained, at least in part, on images of plants associated with representations of indicators of the plants' health (e.g. the plants' diameters, biomass, and/or heights). Such images may be said to be “labelled” with representations of indicators of the plants' health. In some embodiments, the machine learning model comprises a convolutional neural network. The machine learning model may be pre-trained on a non-plant-specific dataset and fine-tuned on images of plants. For example, in some embodiments the parameters of the machine learning model are first trained on a large general images dataset (this phase may be referred to as pre-training), such as ImageNet, and are subsequently trained on a smaller dataset of plant images labelled with representations of depicted plants' health (this phase may be referred to as fine-tuning).

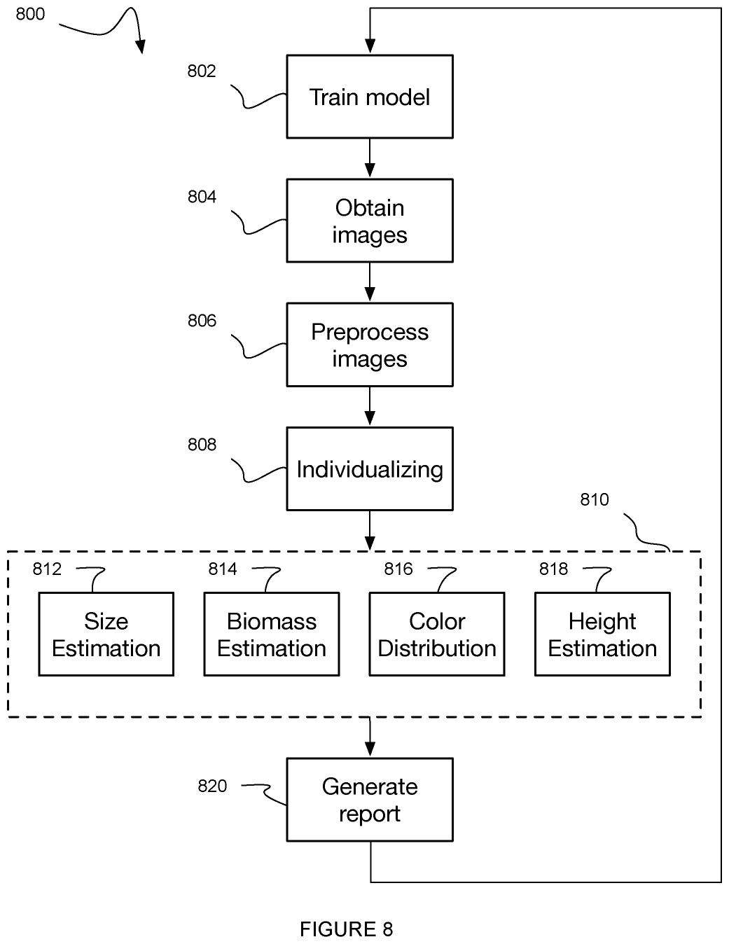

FIG. 8 is a flowchart of an example method 800 for monitoring plant health. Method 800 is performed by a processor, as described elsewhere herein. In some embodiments, method 800 comprises detecting one or more plants by a machine learning model configured to detect plants, e.g. as described elsewhere herein. In such embodiments, method 800 comprises obtaining trained parameters for the machine learning model, for example by obtaining predetermined parameters (e.g. from a user, from a datastore, and/or from any other suitable source) and/or by training parameters of the machine learning model as described elsewhere herein. In the exemplary depicted embodiment of FIG. 8, method 800 comprises training parameters of the machine learning model at act 802.

At act 804, the processor obtains one or more images of plants. The one or more images of plants may be provided by an imaging sensor as described elsewhere herein, retrieved from a datastore and/or a user, and/or otherwise suitably obtained. The one or more images may depict a plurality of plants in a given image, e.g. as shown in FIG. 4A.

Optionally, at act 806, the processor preprocesses the one or more images. For example, the processor may stitch together a plurality of images of overlapping views of one or more plants into an image. For instance, the image of FIG. 4A is a stitched-together image of several images captured by a plurality of sensors of a relatively elongated tray of plants; act 806 may comprise such stitching-together. As another example, the processor may calibrate images to provide similar chromatic characteristics, such as by white-balancing the one or more images (e.g. relative to a reference white card within the field of view of the imaging sensors) to promote accurate color assessment of the plants. As a further example, the processor may segment the images as described elsewhere herein, e.g. to distinguish plant from non-plant portions of the image, such as is shown in FIG. 4B.

At act 808, the processor individualizes the one or more plants in a given image. Individualizing the plants may comprise detecting each plant (e.g. as described with reference to method 300) and extracting a plant image for each plant (e.g. as described elsewhere herein, such as by cropping based on detection regions).

At act 810, the processor determines one or more plant health characteristics for a plant of a plant image extracted from the one or more images. Exemplary plant health characteristic determining steps are shown as optional acts 812, 814, 816, 818; one, some, or all of which may be performed sequentially, in parallel, and/or in any other suitable order. At act 812 the processor estimates a size of the plant, e.g. by estimating a diameter of the plant as described elsewhere herein. At act 814 the processor estimates a biomass of the plant, e.g. as described elsewhere herein. At act 816 the processor determines a color distribution for the plant, for example by clustering colors of plant-labelled pixels around a plurality of color clusters, where each color cluster may be associated with plant health (e.g. deeper greens may be associated with healthier plants for some species). At act 818 the processor estimates a height of the plant, e.g. as described elsewhere herein.

Optionally, at act 820, the processor generates a report comprising estimates of plant health indicators determined at act 810. In some embodiments, the processor provides a report providing indicators of plant health over time. For instance, the processor may update an existing report, for example by providing indicators of plant health relating to earlier points in time from the exiting report and further providing indicators of plant health relating to the (relatively later) point in time to which the one or more images relate. For instance, the processor may generate one or more charts, depicting (e.g.) biomass over time, size (e.g. diameter) over time, color distribution over time, and/or height over time. Such indicators of plant health may be provided for one or more individual plants, and/or may be provided in aggregate (e.g. by providing total biomass, average biomass, average size, average color distribution, average height, and/or any other suitable measure). In some embodiments, the processor provides indicators of plant health for a plurality of plants (e.g. for one point in time and/or for a plurality of points in time). For example, the processor may generate one or more charts, depicting (e.g.) biomass for each detected plant, size (e.g. diameter) for each detected plant, color distribution for each detected plant, and/or height for each detected plant.

Method 300 may repeat one or more times, e.g. for a plurality of images in a sequence of images. For example, imaging sensors may be configured to capture images periodically, such as every week, day, 12 hours, 6 hours, 3 hours, 2 hours, 1 hour, 30 minutes, 20 minutes, 15 minutes, 10 minutes, 5 minutes, 1 minute, 30 seconds, 15 seconds, 10 seconds, 5 seconds, 1 second, and/or with any other suitable frequency (which may be longer or shorter than the foregoing—e.g. the sensors may collect images as frames of a video feed at a frequency of greater than one per second), and the processor may perform method 300 based on those images with the same or a different frequency. For instance, the imaging sensors may capture images daily and the processor may generate daily reports on plant health indicators for the imaged plants daily by performing method 300 daily.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A method for detecting one or more plants in a sequence of images, the method performed by a processor and comprising:
detecting one or more plants in a first image of the sequence of images by, for at least a first plant of the one or more plants:
generating a first detection region for the first plant based on the first image;
initializing a first tracker for the first plant based on the first detection region, the first tracker having a first state; and
generating a first tracking region by the first tracker for the first plant based on the first state;
detecting at least the first plant in a second image of the sequence of images by, for at least the first plant:
updating the first tracker to have a second state based on the second image and the first state; and
generating a second tracking region based on the second state.

2. The method according to claim 1 wherein a center of mass of the plant is substantially stationary between the first and second images.

3. The method according to claim 2 wherein the first plant exhibits growth between the first and second images.

4. The method according to claim 1 wherein detecting at least the first plant in the second image further comprises:
generating a second detection region for the first plant based on the second image;
updating the first tracker to have an updated second state based on the second detection region and the second state; and
generating an updated second tracking region based on the second state.

5. The method according to claim 4 wherein updating the first tracker to have the updated second state comprises determining a union of the second detection region and the second tracking region to generate an updated second detection region and updating the first tracker based on the updated second detection region.

6. The method according to claim 4 wherein updating the first tracker to have the updated second state comprises matching the second tracking region to the second detection region based on a position of the second detection region relative to a position of at least one of: the second tracking region and another tracking region generated by the first tracker for another image of the sequence of images.

7. The method according to claim 6 wherein matching the second tracking region to the second detection region based on the first and second positions comprises matching the second tracking region to the second detection region based on a distance between a center of the second detection region and a center of the at least one of: the second tracking region and the another tracking region.

8. The method according to claim 7 wherein the center of the second detection region comprises a prediction of the first plant's center of mass.

9. The method according to claim 7 wherein matching the second tracking region to the second detection region comprises generating a determination that the distance is less than at least a matching threshold distance and selecting the second detection region from a plurality of detection regions based on the determination.

10. The method according to claim 1 further comprising:
detecting a second plant in a first second-plant (2P) image of the sequence of images by initializing a second tracker for the second plant based on the first 2P image, the second tracker having a first 2P state;
detecting the second plant in a second 2P image of the sequence of images by:
updating the second tracker to have a second 2P state based on the first 2P state and the second 2P image;
wherein the first 2P image comprises at least one of the first image, the second image, and a third image of the sequence of images, and the second 2P image comprises at least one of the second image, the third image, and a fourth image of the sequence of images, the second 2P image subsequent to the first 2P image in the sequence of images.

11. The method according to claim 10 wherein detecting the second plant in the first 2P image comprises:
generating a 2P determination that less than a matching threshold area of at least one of: the first 2P tracking region and a first 2P detection region generated for the second plant overlaps with each of at least one of: one or more detection regions and one or more tracking regions for one or more other plants, the one or more other plants comprising at least the first plant; and
validating the at least one of: the first 2P tracking region and a first 2P detection region based on the 2P determination.

12. The method according to claim 11 comprising:
generating a third detection region;
generating a 3P determination that more than the matching threshold area of the third detection region overlaps with at least one of: the first detection region, the second detection region, the first 2P detection region, and the second 2P detection region; and
invalidating the third detection region based on the 3P determination.

13. The method according to claim 11 wherein the matching threshold area comprises 50% of an area of at least one of: the first 2P tracking region, the first 2P detection region, any of the one or more detection regions for the one or more other plants, and any of the one or more tracking regions for one or more other plants.

14. The method according to claim 1 wherein:
detecting one or more plants in a first image comprises detecting up to n plants in the sequences of images, the up to n plants comprising the first plant, for a predetermined n;
generating the first detection region comprises:
generating at least n+1 detection regions based on the sequence of images; and
selecting up to n detection regions of the at least n+1 detection regions;
initializing the first tracker comprises initializing up to n trackers, each of the up to n trackers comprising a corresponding tracking region based on a corresponding one of the up to n detection regions; and
the up to n plants comprise the first plant, the up to n detection regions comprise the first detection region, and the up to n trackers comprise the first tracker.

15. The method according to claim 14 wherein selecting up to n selected detection regions comprises:
determining, for each of the n+1 detection regions, an associated probability that the detection region contains a plant based on trained parameters of a machine learning model;
determining, for each of the n selected detection regions, that the associated probability for the selected detection region is at least as great as the associated probability for each of the n+1 detection regions not in the up to n selected detection regions; and
selecting up to n of the n+1 detection regions based on the determining, for each of the n selected detection regions, that the associated probability for the selected detection region is at least as great as the associated probability for each of the n+1 detection regions not in the up to n selected detection regions.

16. The method according to claim 14 wherein selecting up to n selected detection regions comprises:
for each of a first and second candidate detection region, determining a spectral characteristic value based on a corresponding portion of the first image; and
selecting the first candidate detection region and rejecting the second candidate detection region based on a comparison of the spectral characteristic value for the first candidate detection region and the spectral characteristic value for the second candidate detection region.

17. The method according to claim 16 wherein:
the spectral characteristic value for at least the first candidate detection region is based on a histogram distance between the corresponding portion of the first image for the first candidate detection region and one or more corresponding portions of the first image for one or more other ones of the n+1 detection regions; and
selecting the first candidate detection region comprises determining that the spectral characteristic value for the first candidate detection region is less than the spectral characteristic value for the second candidate detection region.

18. The method according to claim 1 wherein generating a first detection region comprises:
extracting a plant mask based on trained parameters of a machine learning model, the plant mask mapping regions of the first image to probabilities that the regions include a plant;
identifying one or more objects in the first image based on the plant mask;
generating the first detection region for the first plant based on at least one of the one or more objects in the plant mask.

19. The method according to claim 18 wherein the first detection region comprises a bounding box.

20. The method according to claim 18 wherein extracting the plant mask comprises extracting a background mask based on the trained parameters of the machine learning model, the background mask mapping regions of the first image to probabilities that the regions include non-plant background; and generating the plant mask based on an inversion of the background mask.

21. The method according to claim 1 wherein the method comprises estimating at least one of: a diameter, a biomass, and a height of the first plant based on at least one of: the first tracking region and the second tracking region for the first plant.

22.-42. (canceled)
